(19) United States
(12) Patent Application Publication
(10) Pub. No.: US 2014/0153692 A1
(43) Pub. Date: Jun. 5, 2014

(54) Combining Differential Images by Inverse Riesz Transformation

(71) Applicant: CANON KABUSHIKI KAISHA, Tokyo (JP)

(72) Inventors: Kieran Gerard LARKIN, Putney (AU); Peter Alleine FLETCHER, Rozelle (AU)

(73) Assignee: CANON KABUSHIKI KAISHA, Tokyo (JP)

(21) Appl. No.: 14/092,512

(22) Filed: Nov. 27, 2013

(30) Foreign Application Priority Data
Nov. 30, 2012 (AU) 2012258412

(51) Int. Cl. G01N 23/04; G06T 5/50

(52) U.S. Cl. CPC G01N 23/04; G06T 5/50
USPC 378/36; 382/132

(57) ABSTRACT

A method forms a representative image from a crossed grating fringe pattern interferogram of an object from an interferometer. The method determines a plurality of spectral lobes from the interferogram and selects from the plurality of determined lobes, two substantially orthogonal sidelobes. The selected sidelobes represent spatial differential phase information of the interferogram. The method applies an inverse Riesz transform to the spatial differential phase information of the selected sidelobes to form a transformed differential phase image, and forms from the transformed differential phase image, a representative image emphasising high frequency detail information of the object.

### REFERENCE TO RELATED PATENT APPLICATION(S)

This application claims the benefit under 35 U.S.C. §119 of the filing date of Australian Patent Application No. 2012258412, filed Nov. 30, 2012, hereby incorporated by reference in its entirety as if fully set forth herein.

### TECHNICAL FIELD

The current invention relates to the reconstruction of a representative image from a pair of Fourier sidelobe images and, in particular, to pairs of differential phase images obtained from X-ray Talbot interferometers with crossed gratings.

### BACKGROUND

In areas such as microscopy, interferometry and, more recently, X-ray imaging, there is often a need to form representative images of something that is usually invisible with conventional imaging techniques. Conventional imaging is sensitive to the amount (viz. intensity) of light reflected or transmitted by objects in a scene. Conventional imaging is not usually sensitive to the path length variations of the light emanating from a scene. Path length variations are usually quantified by a parameter known as phase. In the last century or so a large number of techniques have been developed to make (normally invisible) phase variations visible in imaging devices. These techniques include: Zernike phase contrast, Nomarski differential interference contrast, generalized phase contrast, Foucault knife edge, schlieren, shadowgraph, dark-field and wire-test.

More recently there has been progress in extending some of these techniques to X-ray imaging. Also a number of new phase-contrast techniques have been developed for the particularly difficult nature of X-rays (primarily the difficulty of focusing and imaging X-ray beams). These techniques include TIE (Transport of Intensity Equation) phase contrast imaging and ptychography. Another such technique, known as “X-ray Talbot moire interferometry” (XTMI), yields intermediate images which encode one or more differential phase images. The XTMI method using simple linear gratings gives one differential phase image. XTMI with two (crossed) gratings yields two (crossed or orthogonal) differential phase images. Viewing the differential images in the spatial frequency (Fourier) domain is often advantageous as they exist as predominantly separate and distinct regions of concentrated signal energy. These concentrations of energy are commonly referred to as spectral lobes, or sidelobes.

Research in the last few decades has considered how best to reconstruct a representative phase image from one or more differential phase images. In the case where only one differential phase image is available it has been proposed to use the Hilbert transform to construct a representative phase image with meaningful properties. The Hilbert approach is attractive because it avoids some serious problems with the more conventional approach of trying to integrate, in 1-D) the differential phase. In the case where two (orthogonal) differential phase images are available, researchers have proposed various two-dimensional (2-D) integration methods. These methods are essentially the same as those used for two related research problems. The first is the recovery (by 2-D integration) of shape from image shading in computer vision. The second is the recovery of 2-D interferogram phase from wrapped phase via intermediate differential phase images. In all cases the final reconstructed phase is essentially a best estimate of the 2-D integral of differential phases. In many cases however (due, perhaps, to noise or insufficient sampling frequency) it is not possible to reconstruct an acceptably representative phase image. The only known option then is to utilize the original image or images for representation.

In the area of computed tomography (CT) there are two main methods for reconstructing tomographic images from a series of projections. One method, known as filtered back-projection (FBP), generates a so called “back-projection” image by spreading (in 2-D) each (1-D) projection, and then adding all the spread projections. The 2-D back-projected image is then high-pass filtered (de-blurred) by a ramp filter to obtain an approximation to the desired (2-D) CT image. The original proof (by Johann Radon, in the form of the Radon Transform) that an image can be reconstructed from a complete set of its projections entails reconstruction by (1-D) Hilbert transforming each projection, then taking the derivative of the transformed projection, before back-projecting the complete set of projections. The combination of a (1-D) Hilbert transform followed by a derivative is equivalent to a ramp filter. The ramp filter is required to return the Fourier spectrum back to its original level. This has the same effect as FBP, but changes the order of operations. Another variation of this method encodes each of the many projections as its 1-D derivative multiplied by its encoded orientation before back-projection. The final step then is simply a Riesz transformation to yield the final reconstructed tomographic image. This recent variation only applies to absorption or attenuation (i.e. intensity) based projections, not to deviation or phase based projections.

Researchers have proposed that tomographic images be reconstructed with additional high pass filtering (in addition to the high-pass ramp filtering mentioned earlier). An advantage of this proposal is that, for example, applying the ramp filter twice is equivalent to a Laplacian (second derivative) operator, which is a linear operator with bounded spatial support. This essentially means that the final representative image is a high-pass filtered version of the tomographic image normally obtained in CT. This technique has the major advantage that the bounded support operator ensures reconstruction is no longer necessarily spatially global, and exact reconstruction can be applied to small regions, hence giving the method its name: local tomography. The technique is also known as lambda tomography because the additional (isotropic) high pass filter is also known as the lambda operator.

The current state of the art in differential phase imaging means that it is not possible to use a single image to represent the result of measuring two orthogonal differential images unless the two differential images are integrable. Even when the two differentiable images are integrable, the resultant integrated image has the property of suppressing fine detail when compared to the two input differential images. In other words, a single integral image representation either does not work, or when it does work, the single integral image representation loses the fine detail present in the original input images.

### SUMMARY

According to one aspect of the present disclosure there is provided a method of forming a representative image from a crossed grating fringe pattern interferogram of an object from an interferometer, the method comprising:

determining a plurality of spectral lobes from the interferogram;

selecting from the plurality of determined lobes, two substantially orthogonal sidelobes, the selected sidelobes representing spatial differential phase information of the interferogram;

applying an inverse Riesz transform to the spatial differential phase information of the selected sidelobes to form a transformed differential phase image; and

forming from the transformed differential phase image, a representative image emphasising high frequency detail information of the object.

Preferably the representative high frequency detailed image comprises a (real) component and an (imaginary) discrepancy error component, wherein the detailed image can discriminate soft tissue. Typically the interferometer is an x-ray interferometer.

According to another aspect of the present disclosure there is provided a method of forming a representative high frequency emphasized phase image from a phasor image, the method comprising:

differentiating the phasor image to produce an intermediate image having two orthogonal components;

constructing a (complex) image from the two orthogonal components of the intermediate image; and

applying an inverse Riesz transform to the constructed image to form a representative high frequency emphasized phase image, wherein the representative high frequency emphasized image comprises a high pass filtered component and a discrepancy component.

In a further aspect, disclosed is a method of reducing noise in a pair differential images, the method comprising:

combining the differential images into of a complex image having real and imaginary parts;

inverse Riesz transforming the complex image to give an intermediate complex image;

removing the imaginary part of the intermediate complex image;

forward Riesz transforming the real part of the intermediate complex image to form a complex output image having real and imaginary parts; and

associating the real and imaginary parts of the output image with the real and imaginary differential image inputs.

In each of these aspects the Riesz transformation is utilized to combine two differential images in correct orientational distribution proportion to maintain a power spectrum of the images and allow the directional structure in the two images to combine. The power spectrum of the input differential images is maintained without high-pass or low-pass filtering, and the resultant image is representative of an idealized integrated reconstruction having sharper high frequency structures.

According to a further aspect, provided is a method of forming a representative image from a pair of differential input images, the method comprising:

determining a plurality of spectral lobes from the differential input images;

selecting from the plurality of determined lobes, two substantially orthogonal sidelobes, said selected sidelobes representing spatial differential phase information of the differential input images;

blending an orientational distribution of spatial differential phase information of the selected sidelobes by maintaining a power spectrum of the differential input images to form a processed differential phase image; and

forming a representative image emphasising high frequency detail information of the object from the processed differential phase image.

Desirably the differential input images are interferometer images. The processing preferably comprises applying an inverse Riesz transform to the spatial differential phase information. Particularly the blended differential phase image is a complex image and the forming comprises extracting the real part of the processed differential phase image as the representative image.

Other aspects, including computer programs and image processing apparatus are also disclosed.

### BRIEF DESCRIPTION OF THE DRAWINGS

Some aspects of the prior art and at least one embodiment of the invention will now be described with reference to the following drawings, in which:

FIG. 1 is a schematic flow diagram of a prior art method that uses the Hilbert transform;

FIG. 2 is a schematic flow diagram of a prior art method that uses a Poisson divisor;

FIG. 3 is a schematic flow diagram of a prior art method of image reconstruction using the Riesz transform;

FIG. 4 shows a schematic representation of an X-ray Talbot interferometer by which sidelobe images may be formed and detected;

FIGS. 5A and 5B show respectively moire patterns for zero phase differential and with fringe distortions;

FIG. 6 is a schematic representation of the sidelobes of a moire pattern;

FIGS. 7A and 7B show respectively orthogonal differential phase images obtained from the interferogram image of FIG. 5B;

FIG. 8 is a schematic flow diagram of image processing to extract orthogonal differential phase images from two orthogonal sidelobes;

FIG. 9 is a schematic flow diagram of a method of extracting orthogonal differential phase images from a wrapped phase image;

FIG. 10 is a schematic flow diagram of a method of extracting a representative image from orthogonal differential phase images using the Riesz transform;

FIG. 11 is a schematic flow diagram of a method of extracting noise reduced orthogonal differential phase images form a real representative image consequential to the method of FIG. 10;

FIG. 12 illustrates a contour map representation of a representative image obtained using the process of FIG. 10 for the images of FIGS. 5A, 7A and 7B;

FIGS. 13A and 13B form a schematic block diagram of a general purpose computer system upon which arrangements described can be practiced; and

FIG. 14 is a schematic flow diagram of image reconstruction according to the present disclosure.

### DETAILED DESCRIPTION INCLUDING BEST MODE

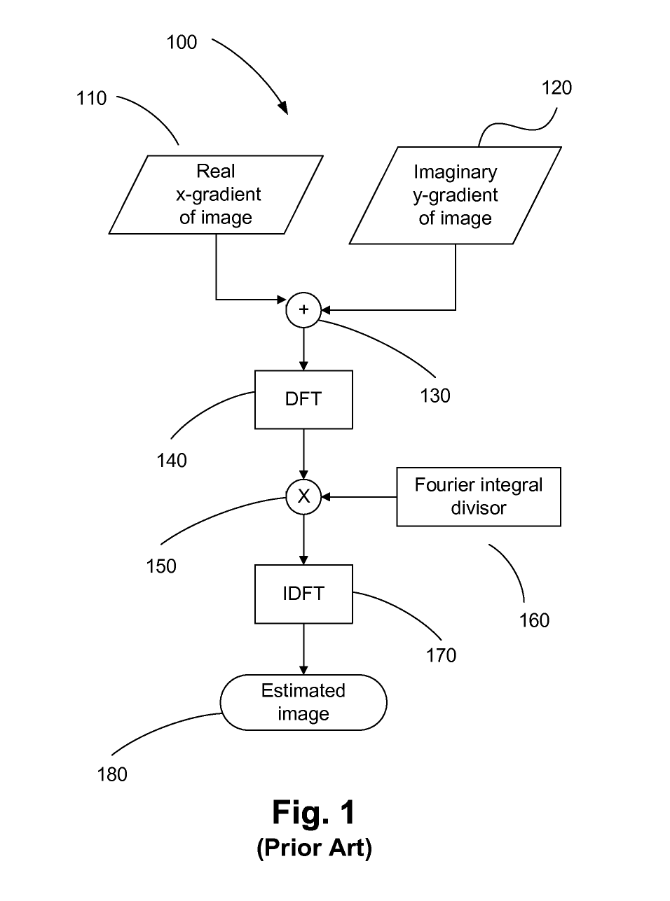

FIG. 1 shows a prior art method 100 consistent with that described in a paper entitled “Using the Hilbert transform for 3D visualisation of differential interference contrast microscope images” M. R. Arnison, C. J. Cogswell, N. I. Smith, P. W. Fekete, K. G. Larkin; Journal of Microscopy, Vol. 199, Pt. 1, July 2000, pp.79-84. The method 100 uses real 110 and imaginary 120 gradient (derivative) components of a single source image, for example obtained from a Fast Fourier Transform (FFT), which are combined at step 130 before the combined image is transformed by a Discrete Fourier Transform (DFT). The transformed image, or the real and imaginary parts thereof, is multiplied 150 with a Fourier integral divisor 160 representing the Fourier transform of an integral kernel. The result is the Inverse DFT 170 which reveals an estimate of the integrated image 180.

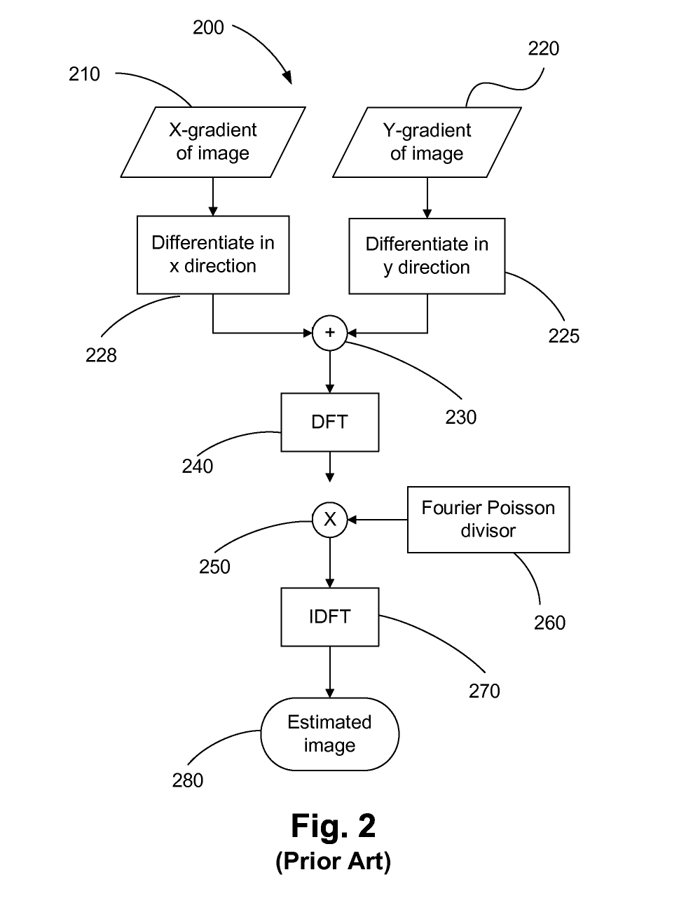

FIG. 2 shows a prior art method 200 representative of the collective disclosures of a paper entitled “A Method for Enforcing Integrability in Shape from Shading”, R. T. Frankot, R. Chellappa; IEEE PAMI, Vol. 10, No 4 July 1988. pp 439-451, and U.S. Pat. No. 5,424,734 to Ghiglia and Romero, granted in 1994. The method 200 uses X 210 and Y 220 gradients of a single source image, each of which is then differentiated at steps 228 and 225 in the corresponding direction. The derivatives are combined at 230 and a DFT 240 forms a transformed image. The transformed image is integrated by multiplication 250 with a Fourier Poisson divisor 260 before an Inverse DFT stage 270 which produces an estimated image 280. This approach involves division in the Fourier domain and full integration of two scalar derivative images.

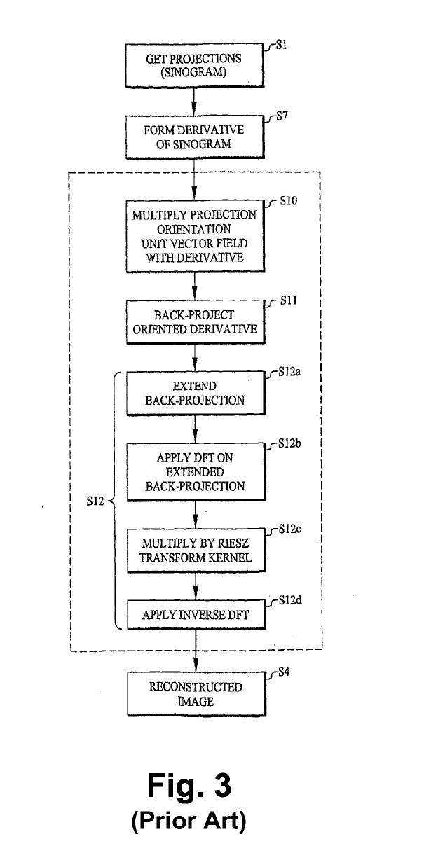

FIG. 3 shows a prior art method of image reconstruction, in fact extracted from US Patent Publication No. US 2011/0142311 (Felsberg et al), published Jun. 16, 2011. In the approach of FIG. 3, a back projection image is extended using multiplication by a Riesz transform kernel.

### Context

The arrangements presently disclosed pertain to generating a single representative image from processes which inherently produce two or more Fourier spectrum sidelobes, each sidelobe corresponding to a differential spatial image, and in particular a differential spatial phase image. As discussed above, it has been shown that high-pass filtered reconstructions, such as the lambda tomograms can be considered representative images wherein the small features are enhanced relative to conventional tomograms.

It is desirable to have a technique which avoids the instabilities inherent in 2-D reconstruction using integration-based methods. Integration-based techniques selectively enhance low spatial frequencies to such an extent that very low frequencies can excessively dominate reconstruction and create unacceptable image distortions.

The presently disclosed arrangements achieve stability by maintaining the power spectrum of the input differential images. A Riesz transformation is utilized to combine two differential images in the correct proportions which maintain the power spectrum yet allow the directional structure in the two images to combine seamlessly. The resultant image is representative in that it resembles the idealized integrated reconstruction, except it has emphasised or sharper high frequency structures.

In addition to the foregoing attributes the methods disclosed herein give a resultant image which maintains the idealized symmetry of edge and lines structures, such symmetry otherwise being lost in the separate differential images.

A further advantage of combining differential images using a Riesz transform is that a secondary image is also generated. The secondary image contains all the image structure that is inconsistent with the model of a single underlying idealized, non-differential image. Essentially this secondary image summarizes the discrepancy between orthogonal differential images, and as such may be used as a measure of the reliability, or as a confidence map of the primary output image.

### Overview

The operation of the presently disclosed arrangements are more concisely described in terms of equations encapsulating the gradient derivatives and Riesz transforms of 2-D functions or images. The mathematics is further simplified by using complex notation. However the process can also be described in terms of vector algebra, matrix algebra, tensor algebra, and even more generally by various Clifford algebra. In the following analysis the simplest approach in 2-D, using complex notation, is utilised.

Multiple differential images can be prepared for visualization as a single image through application of the inverse Riesz transform. The Riesz transform is a linear operator with very stable performance because it does not change the power spectrum of the input signal. The present methods have the advantage that they maintain the high resolution enhancement of the individual differential images, yet combine the images meaningfully into a single representative image with no directional preferences or artefacts.

### Basic System Definitions

The following simplified analysis uses continuous domain Fourier transforms, but discrete, pixel-based analysis using discrete Fourier transforms (DFTs) and fast Fourier transforms (FFTs) can be developed in a very similar manner—essentially paralleling the continuous analysis. First consider a two dimensional function ƒ(x, y) underlying an imaging process. The horizontal and vertical coordinate system is defined conventionally by the variables (x, y).

Simple differential images are of the following form:

$${f}_{x} = \frac{\partial f ( x , y )}{\partial x} , {f}_{y} = \frac{\partial f ( x , y )}{\partial y} \qquad Equation 1$$

The function can be considered in the Fourier domain after Fourier transformation defined as follows:

$$F ( u , v ) ≡ {\int }_{- ∞}^{+ ∞} {\int }_{- ∞}^{+ ∞} f ( x , y ) exp [ 2 π i ( ux + vy ) ] d x d y \qquad Equation 2$$

The horizontal and vertical Fourier coordinate system is defined conventionally by the variables (u, v). The convenient notation of the double-headed arrow is used to represent Forward and inverse Fourier transformation (FT):

$$f ( x , y ) {}^{FT} F ( u , v ) \qquad Equation 3$$

The well-known Fourier derivative theorem can then be represented as follows for the x and y derivatives respectively:

$$f ( x , y ) {}^{FT} F ( u , v ) \\ {f}_{x} ( x , y ) {}^{FT} - 2 π i uF ( u , v ) \\ {f}_{y} ( x , y ) {}^{FT} - 2 πi vF ( u , v ) \qquad Equation 4$$

The gradient operator D{ } represented in complex number notation is defined in terms of the x and y derivatives as:

$$\begin{matrix}D \{ f ( x , y ) \} = \frac{\partial f}{\partial x} + i \frac{\partial f}{\partial y} \\ = {}^{FT} - 2 π i ( u + i v ) F ( u , v ) \\ = - 2 πi q {e}^{iφ} F ( u , v )\end{matrix} \qquad Equation 5$$

The polar Fourier coordinate system (q, φ) is defined:

$$\begin{matrix}u = q cos φ \\ v = q sin φ\end{matrix} \} , \begin{matrix}tan φ = v / u \\ {q}^{2} = {u}^{2} + {v}^{2}\end{matrix} \} \qquad Equation 6$$

In complex notation the n^{th} order Riesz transform Rₙ{ } is defined as:

$${R}_{n} \{ f ( x , y ) \} {}^{FT} {e}^{+ in φ} F ( u , v ) \qquad Equation 7$$

The above action can be summarized as the Riesz transform is equivalent to a unit modulus multiplication in the Fourier domain by a spiral phase factor.

### Crossed Grating Talbot Moire Fringe Patterns

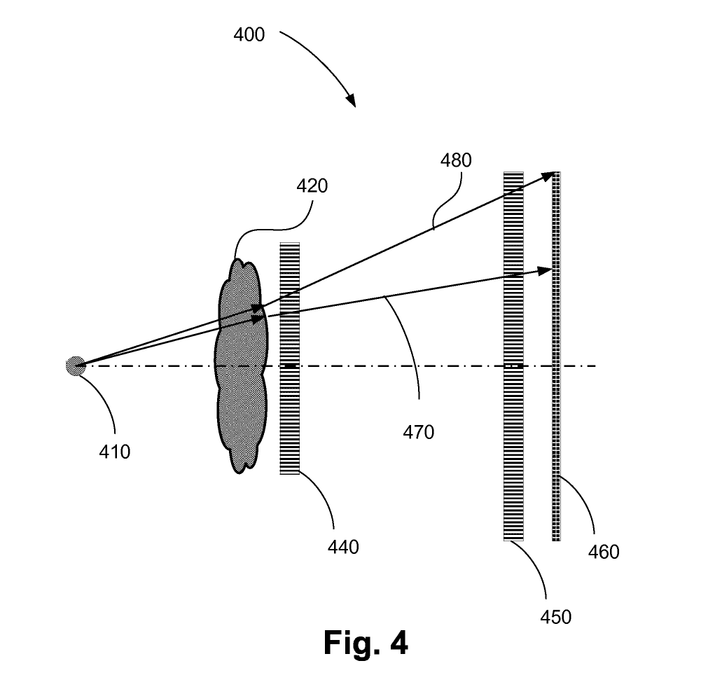

FIG. 4 is the side view of a grating system 400, such as formed by an x-ray Talbot interferometer, which generates a moire fringe pattern on a sensor 460. The system 400 is described in more detail later in this document. The essential product of this apparatus is an image with the following mathematical form:

ρ(x, y)=a(x, y){1+mₓ(x, y)cos[ψₓ(x, y)+2πu₀]}{1+m_{y}(x, y)cos[ψ_{y}(x, y)+2πv₀]} Equation 8

The various symbols in Equation (8) are defined as follows:

the overall absorption factor, as a function of position, is a(x, y);

the x direction partial modulation, as a function of position, is mₓ(x, y);

the y direction partial modulation, as a function of position, is m_{y}(x, y);

the x direction phase differential, related to the total optical paths ψ(x, y) length through the object 420 is ψₓ(x, y);

the y direction phase differential, related to the total optical paths ψ(x, y) length through the object 420 is ψₓ(x, y);

the nominal spatial frequency in the x direction is u₀;

the nominal spatial frequency in the y direction is v₀; and

the x axis points into the paper and is perpendicular to the plane, whereas the y-axis is vertical in the plane of the paper.

In general it is possible to vary the proportion of x and y phase differentials in the first and second cosine terms of Equation (8) by changing the moire pattern due to the relative alignment of a first grating 440 and a second grating 450 as seen in FIG. 4. A slight misalignment of ratings 440 and 450 gives rise to the moire effect. For simplicity of the following analysis, the x and y axis are assumed to line up with the phase differentials.

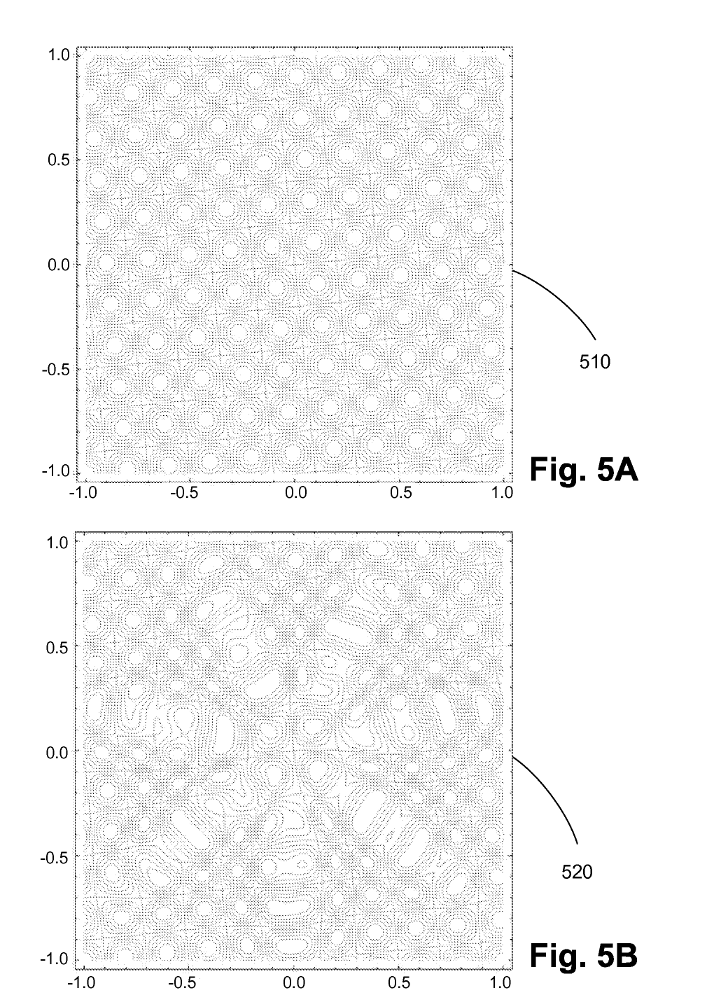

Examples of moire patterns are shown in FIGS. 5A and 5B. The pattern 510 of FIG. 5A is a reference pattern in which the differential phases are set to zero, and would for example be obtained when Talbot imaging air (no target or object). The pattern 520 of FIG. 5B shows the fringe distortions due to an object 420 being placed in the grating system 400. As grey-scales are not easy to reproduce in patent documents FIGS. 5A and 5B are shown as grey-scale contour maps.

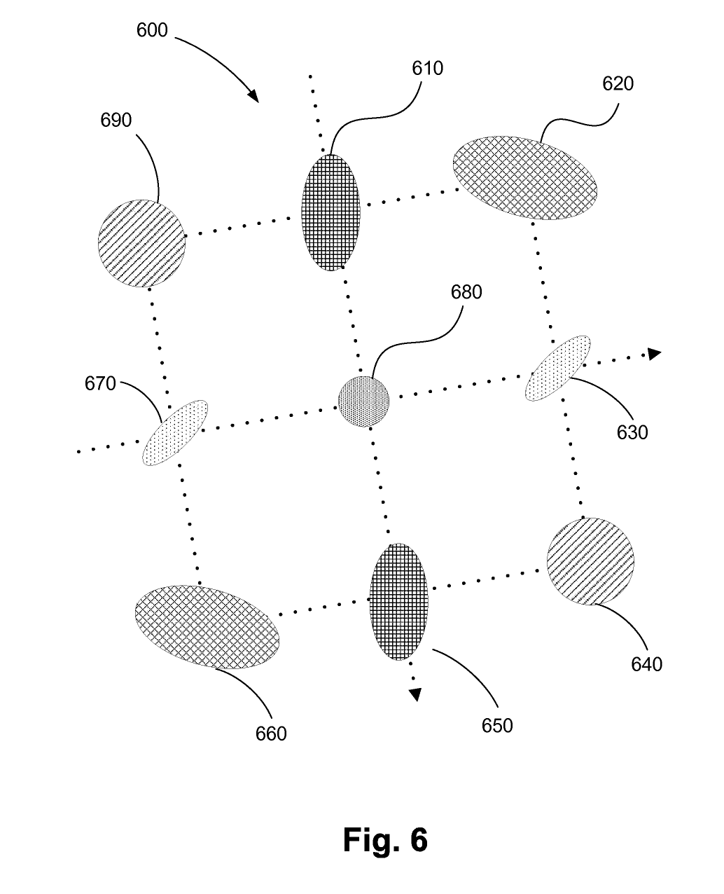

In the Fourier domain such a crossed grating moire produces nine distinct sidelobes, like those shown in FIG. 6. In FIG. 6, a central lobe 680 is also known as the DC lobe. The Fourier transform of Equation (8) is as follows:

P(u, v)=A(u, v) [symbol] {δ(u, v)+Cₓ(u−u₀, v)+C*ₓ(u+u₀, v)} [symbol] {δ(u, v)+C_{y}(u, v−v₀)+C*_{y}(u, v+c₀)} Equation 9

Where the functions are defined:

$${m}_{x} ( x , y ) exp [ {iψ}_{x} ( x , y ) ] / 2 {}^{FT} {C}_{x} ( u , v ) \\ {m}_{y} ( x , y ) exp [ {iψ}_{y} ( x , y ) ] / 2 {}^{FT} {C}_{y} ( u , v ) \\ 1 {}^{FT} δ ( u , v ) \\ a ( x , y ) {}^{FT} A ( u , v ) \\ ρ ( x , y ) {}^{FT} P ( u , v ) \qquad Equation 10$$

Two dimensional convolution is represented by the [symbol] symbol. Equation (9) results in 3×3 sidelobes, that is to say nine distinct sidelobes as depicted in FIG. 6. The lobes predominantly aligned with the x direction are the lobes 630 and 670. The lobes 630, 670 are mathematically related by a complex Hermitian property. The lobes predominantly aligned with the y direction are lobes 610 and 650. There are also two pairs of diagonal lobes, one pair 620 and 660, and the second pair 640 and 690.

Complete phase differential information can be obtained from just two sidelobes, if the sidelobes are largely orthogonal. For example sidelobe 630 and sidelobe 610 represent the following mathematical functions:

$$\begin{matrix}sidelobe 630 {C}_{x} ( u - {u}_{0} , v ) {}^{FT} {m}_{x} ( x , y ) exp [ i {ψ}_{x} ( x , y ) + 2 π {u}_{0} ] / 2 & Equation 11 \\ sidelobe 610 {C}_{y} ( u , v - {v}_{0} ) {}^{FT} {m}_{y} ( x , y ) exp [ i {ψ}_{y} ( x , y ) + 2 π {v}_{0} ] / 2 & Equation 12\end{matrix}$$

The nominal frequencies in the x and y directions, u₀ and v₀, respectively are subtracted leaving the following differential phase images:

Arg{mₓ(x, y)exp└i ψₓ(x, y)+2πu₀┘/2}−2πu₀=ψₓ(x, y) Equation 13

Arg{m_{y}(x, y)exp[i ψ_{y}(x, y)+2πv₀]/2}−2πvd₀ψ_{y}(x, y) Equation 14

In other words, a pair of orthogonal differential phase images can be derived from a pair of orthogonal sidelobes by Fourier transformation. The removal of spatial linear phase (2πu₀, 2πv₀) is equivalent to a translation operation in the Fourier domain. The translation corresponds to shifting each sidelobe back to the central or DC value. This means that each differential phase image is essentially encoded in a sidelobe which is shifted back to the frequency origin. All linear reconstruction operations in the spatial domain are equivalent to a corresponding operation in the Fourier domain.

In the following analysis we can replace the occurrence of scalar differential images ƒₓ(x, y) and ƒ_{y}(x, y) with phase differential images ψₓ(x, y) and ψ_{y}(x, y), as long as the phase differentials are understood to be properly unwrapped phases. It is also possible to replace images ƒₓ(x, y) and ƒ_{y}(x, y) in the following analysis with the partial modulation images mₓ(x, y) and m_{y}(x, y).

### Partial Reconstruction by Riesz Transform

The first step in the reconstruction is to combine the two partial derivative images into a single complex image g(x, y) defined as:

$${g}_{∥} ( x , y ) = {f}_{x} ( x , y ) + i {f}_{y} ( x , y ) = ( \frac{\partial }{\partial x} + i \frac{\partial }{\partial y} ) f ( x , y ) \qquad Equation 15$$

The Fourier transform of the complex image is shown to be:

$$\begin{matrix}{g}_{∥} ( x , y ) = {}^{FT} {G}_{∥} ( u , v ) \\ = - 2 π i ( u + i v ) F ( u , v ) \\ = - 2 π i q {e}^{i φ} F ( u , v )\end{matrix} \qquad Equation 16$$

Applying the Riesz transform R{ } of order −1 (minus one), more commonly known as the inverse Riesz transform, then the following result is obtained:

$${R}_{- 1} \{ {g}_{∥} ( x , y ) \} {}^{FT} {e}^{- i φ} {G}_{∥} ( u , v ) = {e}^{- i φ} ( - i ) 2 π q {e}^{+ i φ} F ( u , v ) = ( - 2 π i ) q F ( u , v ) \qquad Equation 17$$

Introducing a further complex factor into the operator on the left hand side of the equation gives the following result to resolve the right hand side:

$$i {R}_{- 1} \{ {g}_{∥} ( x , y ) \} {}^{FT} ( 2 π q ) F ( u , v ) \qquad Equation 18$$

The above operation can be explained as the action of a complex Riesz operator on a complex gradient image resulting in a high-pass, isotropic ramp (2πq) filtered version of the original underlying function. In terms of the lambda operator Λ{ } the equation can be written:

$$i {R}_{- 1} \{ {f}_{x} ( x , y ) + i {f}_{y} ( x , y ) \} = Λ \{ f ( x , y ) \} {}^{FT} ( 2 π q ) F ( u , v ) \qquad Equation 19$$

Alternatively, reversing the direction of the complex gradient allows inversion with the forward Riesz transform R₊₁{ }:

$$i {R}_{+ 1} \{ {f}_{x} ( x , y ) + i {f}_{y} ( x , y ) \} = Λ \{ f ( x , y ) \} {}^{FT} ( 2 π q ) F ( u , v ) \qquad Equation 20$$

The action of the inverse Riesz transformation in Equations 17, 18, 19 and 20 can be described as orientational distribution blending. Spatial structures in the two differential images are blended according to the orientational parameter φ of the Riesz operator in Equation 17. The blending operation is difficult to implement in the spatial domain but is simple to implement in the Fourier domain.

### Riesz Transform Discrepancy

The preceding analysis assumes perfect differential input images, for example where the sidelobes are perfectly orthogonal. If there are any inconsistencies of the two differential terms, then an imaginary component will be yielded along with the real output in Equations (12) and (13). The imaginary part essentially relates to curl-like component in the complex input image and may be considered a discrepancy of error (ε) component. Curl-like components are perpendicular and orthogonal (rotated by 90°) to the desired gradient-like components:

$$\begin{matrix}{g}_{⊥} ( x , y ) = i ( {h}_{x} ( x , y ) + i {h}_{y} ( x , y ) ) = ( - \frac{\partial }{\partial y} + i \frac{\partial }{\partial x} ) h ( x , y ) & Equation 21 a \\ i {R}_{- 1} \{ {g}_{⊥} ( x , y ) \} {}^{FT} i {e}^{- i φ} {G}_{⊥} ( u , v ) = i {e}^{- i φ} ( - i ) 2 π q {e}^{+ i φ} i H ( u , v ) = i ( 2 π ) q H ( u , v ) & Equation 21 b \\ i {R}_{- 1} \{ {g}_{⊥} ( x , y ) \} = i Λ h ( x , y ) & Equation 22 \end{matrix}$$

The inverse Riesz transformation has the overall effect of separating the gradient-like components and the curl-like components into the real and imaginary parts of the output complex image.

iR₋₁{g_{∥}(x, y)+g_{⊥}(x, y)}=Λƒ(x, y)+iΛh(x, y) Equation 23

### Double Riesz Transformation Noise Reduction

From the preceding analysis it is clear that any image structure incompatible with the underlying gradient assumption will appear as an imaginary discrepancy term, ih(x,y). This term may be trivially removed by simply retaining the corresponding real term, ƒ(x,y). It is then possible to simply apply the forward Riesz transformation to obtain an improved estimate of the original complex gradient image:

[symbol]

└iR₋₁{g_{∥}(x, y)+g_{⊥}(x, y)}┘=Λƒ(x, y) Equation 24

R₊₁{ [symbol] └iR₋₁{g_{∥}(x, y)+g_{⊥}(x, y)}┘}=D{ƒ(x, y)}=g_{∥}(x, y) Equation 25

From Equations (24) and (25), it transpires that random noise is equally likely to give curl-like and gradient-like complex noise. So applying the above double Riesz transformation process will remove approximately half the random noise in the grating system 400.

### Automatic Normalization

The preceding analysis assumes that the input differential input images are generated from the same imaging process, which means that the relative weighting of the two images is properly balanced. If however the two differential images are generated in separate processes, then there is the possibility of an imbalance occurring. By careful analysis it is possible to detect such an imbalance and perform correction so that the final recovered image minimizes any imbalance effects. The following correction process can be applied in the spatial domain or the Fourier domain.

$${f}_{1}^{′} ( x , y ) = {f}_{x}^{′ } ( x , y ) = {α}_{1} \frac{\partial }{\partial x} f ( x , y ) \\ {f}_{2}^{′} ( x , y ) = {f}_{y}^{′ } ( x , y ) = {α}_{2} \frac{\partial }{\partial y} f ( x , y ) \qquad Equation 26$$

Fourier Domain

$${f}_{x}^{′} ( x , y ) {}^{FT} - 2 {α}_{1} π i uF ( u , v ) = {F}_{1} ( u , v ) \\ {f}_{y}^{′} ( x , y ) {}^{FT} - 2 {α}_{2} π i vF ( u , v ) = {F}_{2} ( u , v ) \qquad Equation 27$$

Cross derivatives are cross-multiples in Fourier domain:

$${f}_{xy}^{′} ( x , y ) {}^{FT} {α}_{1} ( - 2 π i u ) ( - 2 π i v ) F ( u , v ) = {α}_{1} ( 2 π ) ( 2 π ) uv F ( u , v ) \\ {f}_{yx}^{′} ( x , y ) {}^{FT} {α}_{2} ( - 2 π i v ) ( - 2 π i u ) F ( u , v ) = {α}_{2} ( 2 π ) ( 2 π ) uv F ( u , v ) \qquad Equation 28$$

So the cross derivatives are identical up to a multiplicative factor:

ƒ′_{xy}(x, y)=α₁ƒ_{xy}(x, y)

ƒ′_{yx}(x, y)=α₂ƒ_{xy} (x, y) Equation 29

Least squares estimation can be used to find the ratio of factors under the assumption of uncorrelated additive noise. A particular simple approach is to compute the total energy of the cross derivatives. By Plancherel's (Parseval) theorem, the total spatial energy is identical with the total Fourier energy; so either domain may be used to perform the computation. However in some implementations, it may be advantageous to compute a power measure with less high frequency emphasis, and so the present inventors consider that the process is more conveniently performed in the Fourier domain:

$${\int \int }_{X} {\vert {f}_{xy}^{′} ( x , y ) \vert}^{2} d x d y {\int \int }_{U} {\vert {α}_{1} ( 2 π ) ( 2 π ) uv F ( u , v ) \vert}^{2} d u d v = {α}_{1}^{2} E \\ {\int \int }_{X} {\vert {f}_{yx}^{′} ( x , y ) \vert}^{2} d x d y {\int \int }_{U} {\vert {α}_{2} ( 2 π ) ( 2 π ) uv F ( u , v ) \vert}^{2} d u d v = {α}_{2}^{2} E \qquad Equation 30$$

The regions of integration X in the spatial domain, and U in the Fourier domain, can be chosen to be small or large, depending on the particular implementation. In the limit the domain can be the complete spatial or spectral domain.

The ratio of factors is then found from:

$$\frac{{α}_{1}^{2}}{{α}_{2}^{2}} = \frac{{\int \int }_{U} {\vert v {F}_{1} ( u , v ) \vert}^{2} d u d v}{{\int \int }_{U} {\vert v {F}_{2} ( u , v ) \vert}^{2} d u d v} \qquad Equation 31$$

Alternative spectral weighting gives a better balance of noise versus the final image spectrum:

$$\frac{{α}_{1}^{2}}{{α}_{2}^{2}} = \frac{{\int \int }_{U} {q}^{- 1} {\vert v {F}_{1} ( u , v ) \vert}^{2} d u d v}{{\int \int }_{U} {q}^{- 1} {\vert v {F}_{2} ( u , v ) \vert}^{2} d u d v} \qquad Equation 32$$

Other powers of q are also possible, depending on application requirements.

### Automated Alignment

In a similar way to the above normalization it is possible to automatically register misaligned images. This is only necessary in a system that does not simultaneously generate the two orthogonal derivatives. Crossed grating systems will generate orthogonal derivatives simultaneously. One dimensional grating systems generate derivatives separately, as do classical systems such as Nomarski differential interference contrast (DIC) microscopes. If the derivatives are generated separately it will, in general, be necessary to compensate both normalization and alignment. So the starting point is Equation (28) with possible misalignment:

ƒ′_{xy}(x, y)=α₁ƒ_{xy}(x, y)

ƒ′_{yx}(x, y)=α₂ƒ_{xy}(x−x₀, y−y₀) Equation 33

Two dimensional cross-correlation, using FFT to speed up computation produces a highly peaked function. The location of the peak gives the misalignment (x₀, y₀) parameters, whilst the relative peak heights of the cross-correlation and the two autocorrelations gives the normalization factors (α₁, α₂).

ACₚₑₐₖ{ƒ′_{xy}}∝α₁²

ACₚₑₐₖ{ƒ′_{yx}}∝α₂²

CCₚₑₐₗ{ƒ′_{xy}, ƒ′_{yx}}∝α₁α₂

CC_{peakloc}{ƒ′_{xy}, ƒ′_{yx}}=(x₀, y₀) Equation 34

### EXAMPLE 1

FIG. 4 shows a typical X-ray Talbot moire imaging (grating) system 400. A compact source 410 emits X-rays which then pass through a test object 420. Typically the test object is a biological sample or part of a human patient's anatomy. Alternatively the test object 420 may be physical apparatus or structure, such as luggage transiting an airport security screening location. The X-rays continue on through a first grating 440, then on towards a second grating 450, and finally on to an X-ray sensor 460 where the intensity of X-rays is registered. Typically the X-ray sensor 460 comprises an X-ray scintillator material and a light sensitive array to detect the intensity and location of scintillations. The relative deflection or diffraction of ray paths, for example ray paths 470 and 480, produces a misalignment of the grating shadow from the first grating 440 on the second grating 450, resulting in the desired moire effect detectable upon the sensor 460. More detailed analysis shows the grating shadow to be a differential phase factor in the overall moire pattern equations. The first grating 440 can be a pure phase grating, or an amplitude grating, but the second grating 450 must be an amplitude grating if the system 400 is to work with a generally available incoherent source instead of an enormously expensive coherent synchrotron source.

The compact source 410 can be replaced by an array of compact sources 410 with spacing chosen to reinforce exactly at a spacing defined by the first grating 440 and the second grating 450. Such a system 400 can achieve improved X-ray throughput.

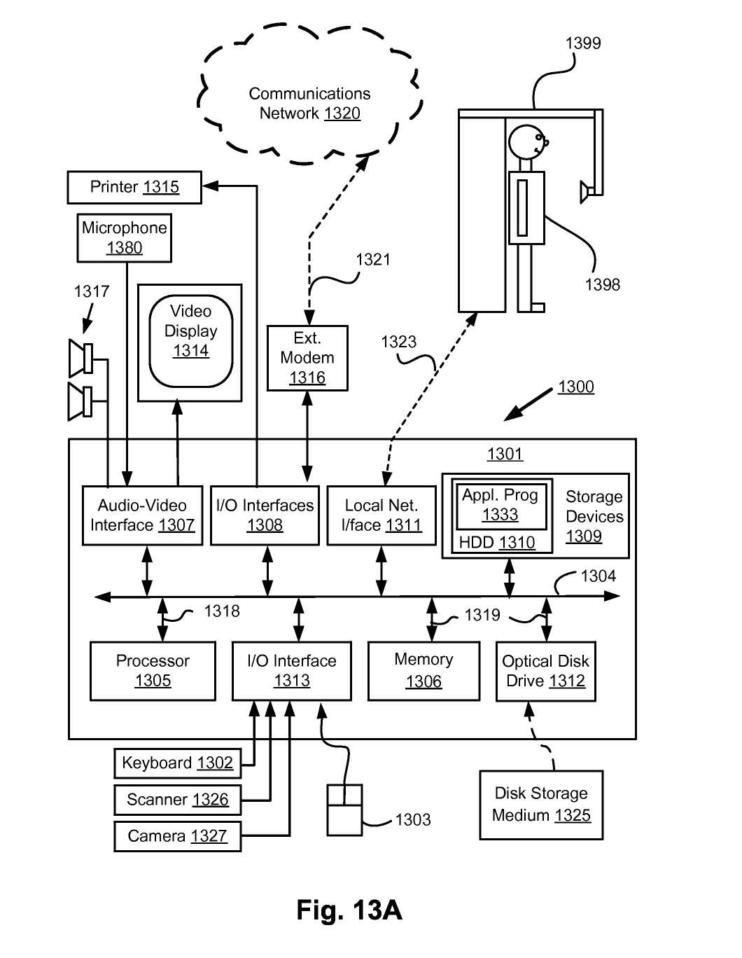

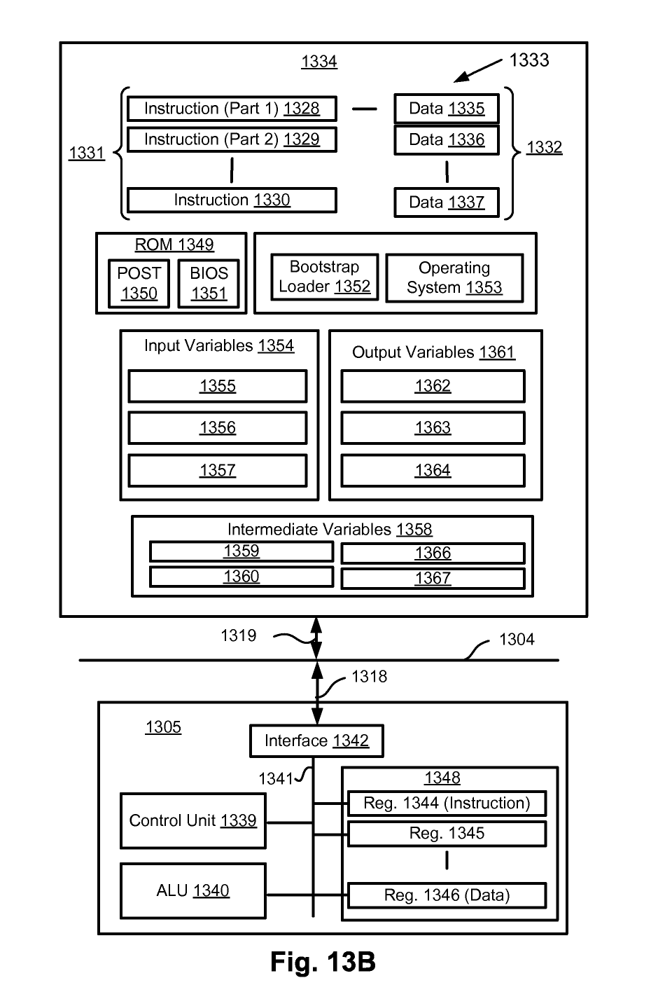

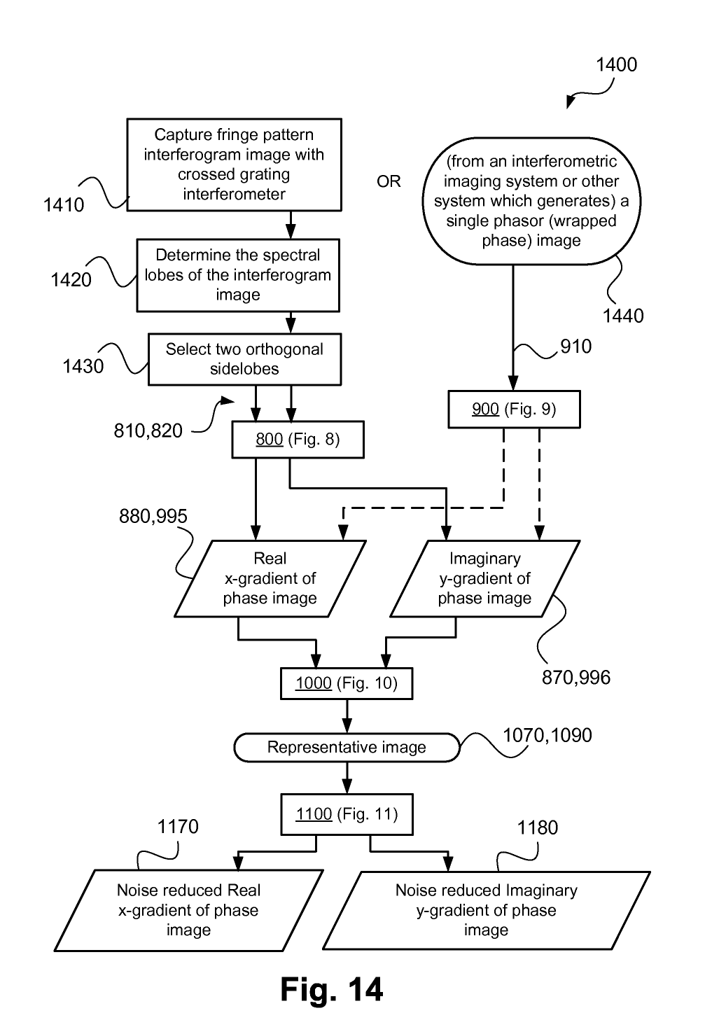

FIGS. 13A and 13B depict a general-purpose computer system 1300, upon which the various processing arrangements described can be practiced.

As seen in FIG. 13A, the computer system 1300 includes: a computer module 1301; input devices such as a keyboard 1302, a mouse pointer device 1303, a scanner 1326, a camera 1327, and a microphone 1380; and output devices including a printer 1315, a display device 1314 and loudspeakers 1317. The computer system 1300 is seen coupled to an X-ray device 1399 consistent with those encompassed by the present disclosure, of which the grating system 400 is but one example. The X-ray device 1399 may be used to image a human subject 1398 as illustrated, or physical apparatus as discussed above. With the computer system 1300 the imaging is preferably performed by means of interferometry, thus providing for FIG. 13A to represent an x-ray interferometer system. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an number of input/output (I/O) interfaces including: an audio-video interface 1307 that couples to the video display 1314, loudspeakers 1317 and microphone 1380; an I/O interface 1313 that couples to the keyboard 1302, mouse 1303, scanner 1326, camera 1327 and optionally a joystick or other human interface device (not illustrated); and an interface 1308 for the external modem 1316 and printer 1315. In some implementations, the modem 1316 may be incorporated within the computer module 1301, for example within the interface 1308. The computer module 1301 also has a local network interface 1311, which permits coupling of the computer system 1300 via a connection 1323 to the X-ray device 1399. The local network interface 1311 may comprise an Ethernet™ circuit card, a Bluetooth™ wireless arrangement or an IEEE 802.11 wireless arrangement; however, numerous other types of interfaces may be practiced for the interface 1311. Other forms of coupling between the X-ray device 1399 and the computer module 1301 may be used as appropriate. The X-ray device 1399 provides image data via the connection 1323 for storage in the computer module 1301, for example on the HDD 1310 and/or in the memory 1306, for subsequent processing in accordance with the present disclosure.

The I/O interfaces 1308 and 1313 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1300.

The components 1305 to 1313 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple Mac™ or a like computer systems.

The methods of image reconstruction may be implemented using the computer system 1300 wherein the processes of FIGS. 4 to 12, to be described, may be implemented as one or more software application programs 1333 executable within the computer system 1300. In particular, the steps of the methods of image reconstruction are effected by instructions 1331 (see FIG. 13B) in the software 1333 that are carried out within the computer system 1300. The software instructions 1331 may be formed as one or more code modules, each for performing one or more particular tasks. The software may also be divided into two separate parts, in which a first part and the corresponding code modules performs the image reconstruction methods and a second part and the corresponding code modules manage a user interface between the first part and the user.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for image reconstruction.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for image reconstruction.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon the display 1314. Through manipulation of typically the keyboard 1302 and the mouse 1303, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1317 and user voice commands input via the microphone 1380.

FIG. 13B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 13A.

When the computer module 1301 is initially powered up, a power-on self-test (POST) program 1350 executes. The POST program 1350 is typically stored in a ROM 1349 of the semiconductor memory 1306 of FIG. 13A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 13A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 13A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 13B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 13A. The execution of a set of the instructions may in some cases result in output of data. Execution may also involve storing data or variables to the memory 1334.

The disclosed image reconstruction arrangements use input variables 1354, which are stored in the memory 1334 in corresponding memory locations 1355, 1356, 1357. The arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 13B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:

(i) a fetch operation, which fetches or reads an instruction 1331 from a memory location 1328, 1329, 1330;

(ii) a decode operation in which the control unit 1339 determines which instruction has been fetched; and

(iii) an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

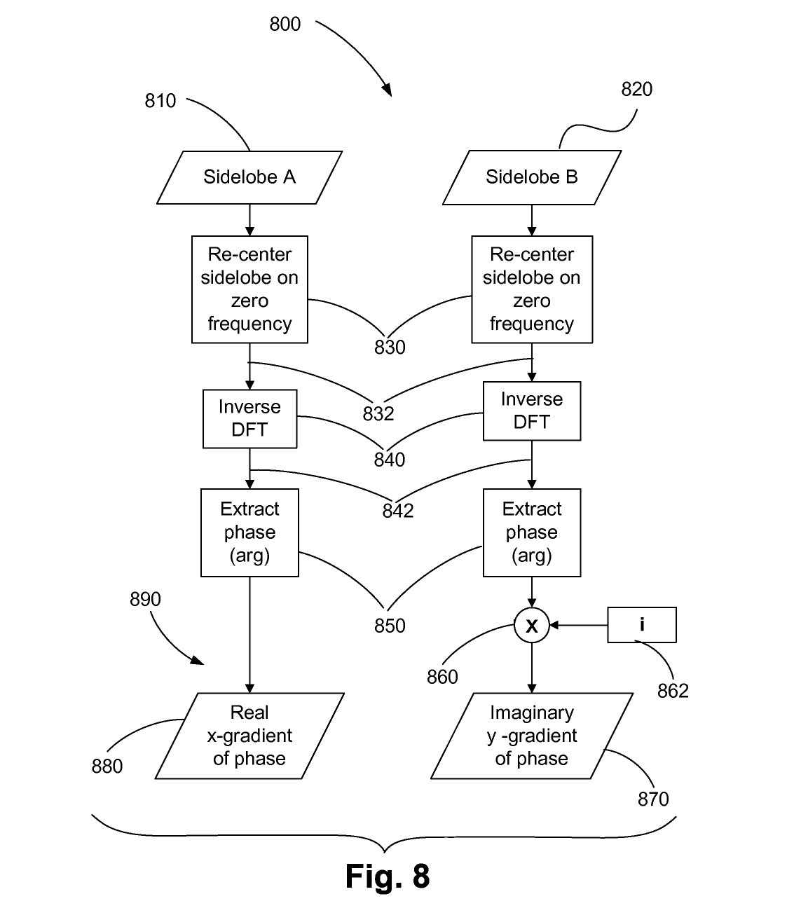

Each step or sub-process in the processes of FIGS. 8 to 11 is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

The methods of image reconstruction may alternatively/additionally be implemented in dedicated hardware such as one or more integrated circuits performing one or more of the functions or sub functions of image reconstruction to be described. Such dedicated hardware may include graphic processors, digital signal processors, or one or more microprocessors and associated memories. Such hardware may be advantageously used for the DFT, IDFT and FFT and IFFT processes to be described.

FIGS. 5A and 5B shows detail of typical moire interferograms. For printing and reproduction of this patent document the grey scale interferogram image typically obtained is represented by a contour map. An undistorted interferogram (fringe pattern) 510 in FIG. 5A is obtained when the object 420 or 1398 is removed, thereby producing a moire interferogram 510 arising solely from the crossed gratings 440 and 450. A differential phase distorted interferogram 520 of FIG. 5B is obtained when an object 420 (1398) is placed in front of the first grating 440. The example shown in FIG. 5B is a seven limbed phase object in can be can be discerned from the fringe distortions, of which each of the seven limbs can be seen radiating from the centre of the interferogram 520. The interferogram 520 is an example of the image output from an X-ray Talbot interferometer device 1399.

Interferograms like those in FIG. 5 reveal a regular structure in the Fourier domain. FIG. 6 shows the typical nine-lobe structure in the Fourier domain. If the modulation of the moire interferograms is sufficiently gentle, then the nine sidelobes 610-690 will be disjoint, that is to say separate and non-overlapping. If the modulation is strong enough, as it is in many actual systems, then the sidelobes will have some degree of overlap with each other.

FIG. 6 shows four Hermitian pairs of “orthogonal” Fourier lobes, and one central DC lobe 680.

In the disjoint case it is trivial to isolate the lobes completely. For example the undistorted fringe pattern 510 in FIG. 5A has substantially disjoint sidelobes, in that each pattern is readily discernable. Furthermore it is possible to select and isolate just two of the nine lobes so that the lobes contain orthogonal differential phase information. In FIG. 6, sidelobes 630 and 610 form an orthogonal pair, as the sidelobes are located on respective orthogonal axes of the spatial Fourier representation of FIG. 6 relative to the centre frequency (fundamental lobe) 680. Sidelobes 620 and 690 form another orthogonal pair in that they subtend a substantially orthogonal angle with the fundamental lobe 680. By inverse Fourier transforming two separated lobe datasets, two differential phase images are obtained. The images are complex, with the magnitude representing the amplitude modulation term and the phase representing the differential phase with a linear carrier phase added. The linear carrier phase can be easily removed. Removal may be, for example, by estimating the mean phase gradient (viz. frequency), and then subtracting the corresponding linear phase to obtain a carrier-free differential phase.

In the non-disjoint case (viz. overlapping) other methods must be used to isolate sidelobes. One method, known as phase shifting interferometry, collects multiple moire interferograms containing different phase offsets (“phase shifts”). The sidelobes are then estimated using linear combinations of the interferograms defined by phase-shifting algorithms. Another method of sidelobe isolation is to find a constraint on the sidelobe shape, then solve a simultaneous equation applying the constraint to all sidelobes. The result is that each sidelobe can be fully isolated, assuming the constraint is substantially valid. Again, the differential phase images are computed by inverse Fourier transforming two orthogonal and isolated sidelobes. The amplitude modulation image is encoded in the modulus and the differential phase is encoded in the phase of the complex image.

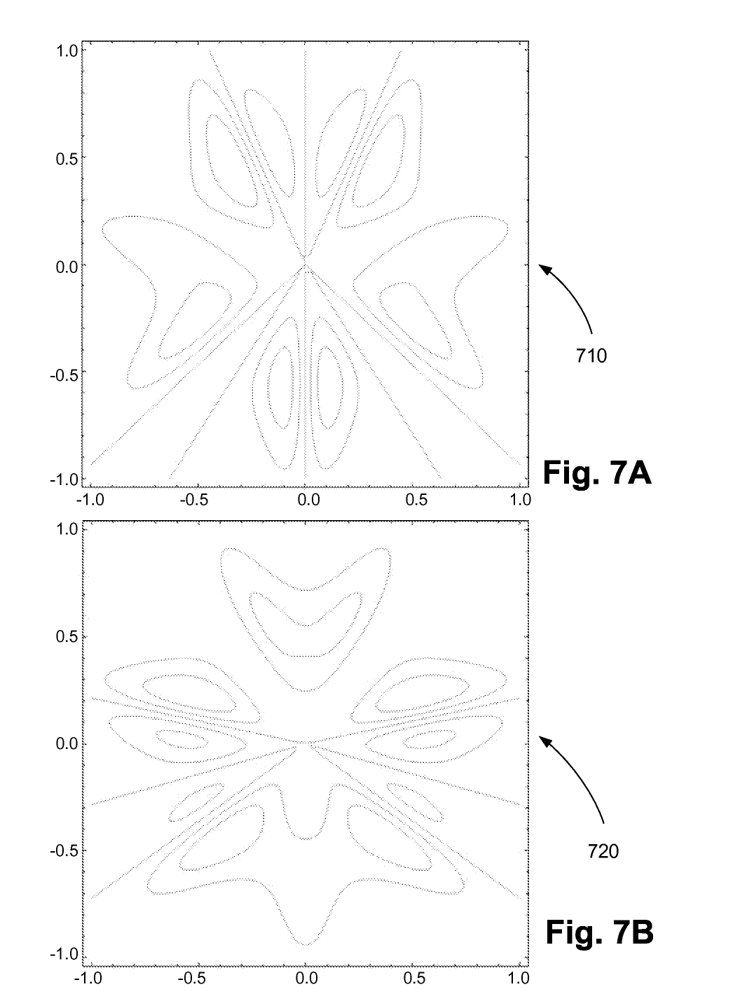

FIGS. 7A and 7B show the two orthogonal differential phase images 710 and 720 respectively that are obtained from the interferogram 520 by demodulation. For printing and scanning of this patent document the grey scale images are again represented by contour maps. There are many different demodulation algorithms in common usage that allow the phase images 710 and 720 to be derived from a digital interferogram image 520.

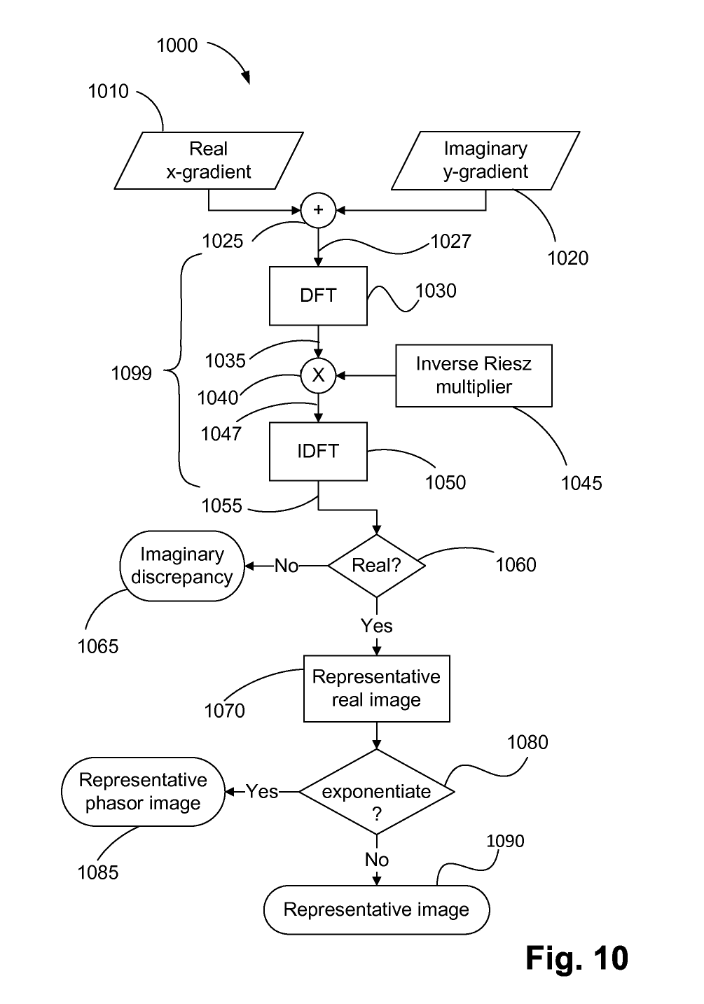

FIG. 8 shows a method 800 for generating two (substantially) orthogonal differential phase images from two orthogonal sidelobes. This figure and subsequent figures are shown utilizing complex algebra for simplicity. Alternatively matrix, vector, tensor or Clifford algebras could also be used, but the flow charts would be somewhat more complicated. The method 800 is typically performed by software recorded in the HDD 1310 of the computer 1301 as executed by the processor 1305. The method 800 takes as input two sidelobe spectra 810 and 820, being that for example derived from DFT processing of a single image (e.g. 520) captured using the X-ray device 1399, and which may be temporarily stored in the memory 1306. The sidelobe spectra 810 and 820 are each shifted in the Fourier plane to the centre frequency (DC) location by corresponding re-centering functions 830. The re-centred spectra 832 are then inverse discrete Fourier transformed (IDFT) 840 to give corresponding complex spatial images 842. The phase of complex spatial images 842 is extracted at step 850 using the arg operator. In the simplest case the arg operator is Arg—essentially the arctangent operator, and the extracted result is the principal value of the phase (that is to say, in the range zero to two pi radians). A more general arg operator can be used and encompasses phase unwrapping beyond the two pi range of the Arg operator. The extracted phase of the sidelobe 810 is considered an output image 880 that contains the desired x-differential phase image. The extracted phase associated with the sidelobe 820 is multiplied at step 860 by the imaginary unit i 862 to form an output image 870 that contains the y-differential image. The real and imaginary parts 880,870 form a differential pair of images, and are then ready for input into an inverse Riesz method 1000 of FIG. 10.

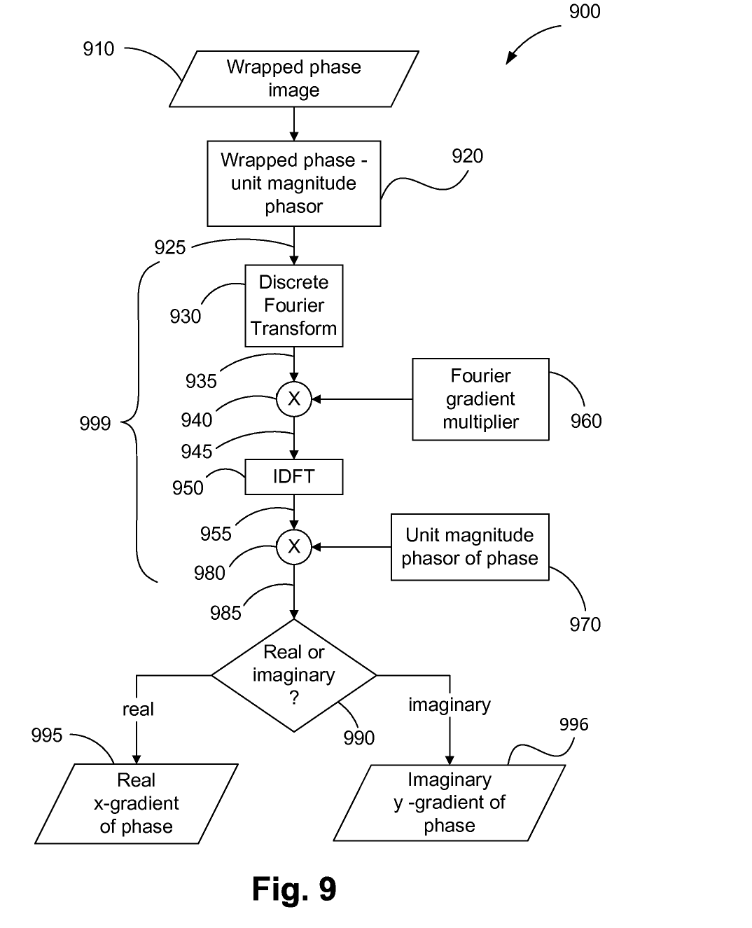

An alternative method of generating a corresponding output to that of FIG. 8 is illustrated in FIG. 14. FIG. 9 shows the alternative approach of a method 900 to obtain the output of FIG. 8 from a wrapped phase input image. The wrapped phase image 910 can be obtained from conventional interferometry or any two dimensional phase estimation technique, such as digital holography. In step 920, the wrapped phase image, ψ_{w}(x,y), 910 is first complex exponentiated according to Equation 35:

p(x, y)=exp[i ψ_{w}(x, y)] Equation 35

to produce a unit magnitude phasor image 925, expressed by the right hand side of Equation 35. The phasor image 925 is then differentiated 999 according to a combination of steps 930-980 represented by Equation 36.

$$\{ \frac{\partial }{\partial x} + i \frac{\partial }{\partial y} \} ψ ( x , y ) = - i {p}^{*} ( x , y ) \{ \frac{\partial }{\partial x} + i \frac{\partial }{\partial y} \} p ( x , y ) \qquad Equation 36$$

On the left hand side of this equation is an estimate of the unwrapped phase derivative. On the right hand side all terms are based on wrapped phase. So the equation represents an unwrapped phase estimator. The differential operation on the right hand side can be advantageously computed in the Fourier domain then transformed back. The image 925 is Fourier transformed by a Discrete Fourier Transform 930 and the resultant Fourier image 935 is then, in step 940, multiplied by a complex Fourier ramp factor 960 to give a term 945, which is then inverse Fourier transformed by an IDFT 950, giving an intermediate spatial image 955. The image 955 is multiplied in step 980 by a complex spatial factor 970 equal to the complex conjugate of the factor defined by Equation 35 to form a complex intermediate image 985. The intermediate image 985 is then split in step 990 into its constituent real part 995 and imaginary part 996. The real and imaginary parts are then ready for input into the inverse Riesz method 1000 of FIG. 10.

FIG. 10 shows a general method 1000 for applying the inverse Riesz method to inputs 1010 and 1020 that are differential phase images, such as those output from the methods of FIG. 8 or 9. The differential inputs 1010 and 1020 are additively combined at step 1025 to construct a complex image 1027 comprising spatial differential phase information The complex image 1027 is then inverse Riesz transformed 1099. The inverse Riesz transform 1099 is performed by a combination of steps in which the image 1027 is discrete Fourier transformed in step 1030 to form an intermediate Fourier image 1035. The image 1035 is then multiplied in step 1040 by a complex inverse Riesz factor 1045, to give a Fourier Riesz image 1047. The image 1047 is inverse discrete Fourier transformed in step 1050 to form a spatial differential phase image 1055. The method 1000 then forms a representative image 1070 by separating at step 1060 the imaginary part 1065 of the image 1055 from the real part of the image 1055, for which the real part forms the representative image 1070. The imaginary part 1065 encodes a discrepancy image consistent with Equations (21a), (21b), (22) and (23). The real part 1070 is a representative high pass detailed image {Λψ(x, y)} 1070 that is a high frequency enhanced or emphasised image, also known as a lambda enhanced image. The representative image 1070 can be regarded as “high-frequency” enhanced, in comparison to prior art approaches. This is because the original gradient images 1010 and 1020 are each considered to provide emphasis in the x-direction and in the y-direction respectively, giving significant detail to the independent images. However, prior art combining of the images 1010, 1020 resulted in a loss of the emphasis. Using the approaches presently disclosed, the high-frequency detail is retained through operation of the Riesz transform maintaining the power spectrum, thereby maintaining the emphasis of high-frequency image components in the combined lambda image 1070 The lambda image 1070 may be complex exponentiated at step 1080 and output as a pure phasor representative image 1085. Alternatively the lambda phase image 1070 can be output directly as the representative image 1090 associated with the input differential images 1010, 1020. The representative images 1070, 1090 are real images.

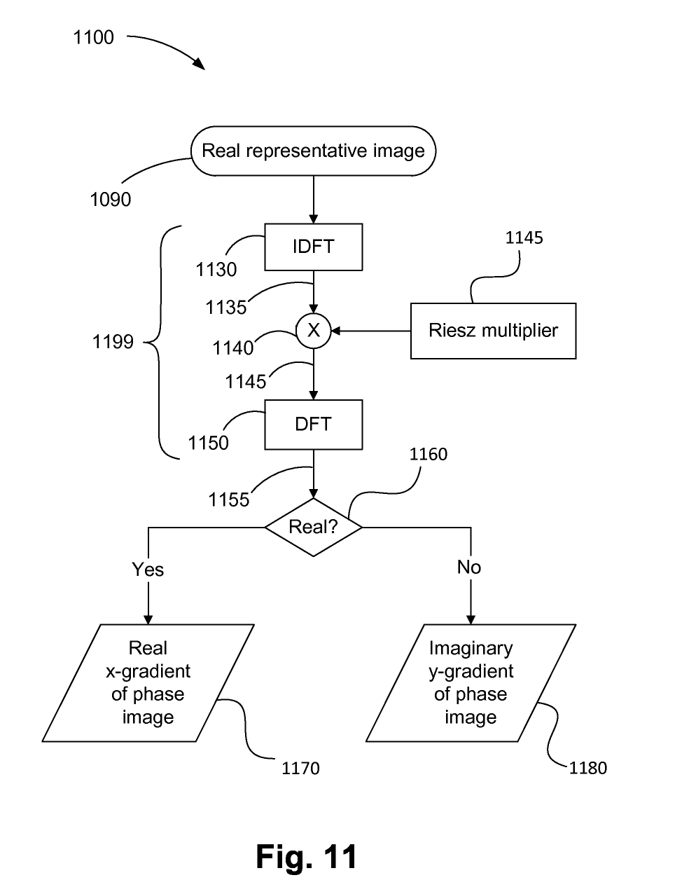

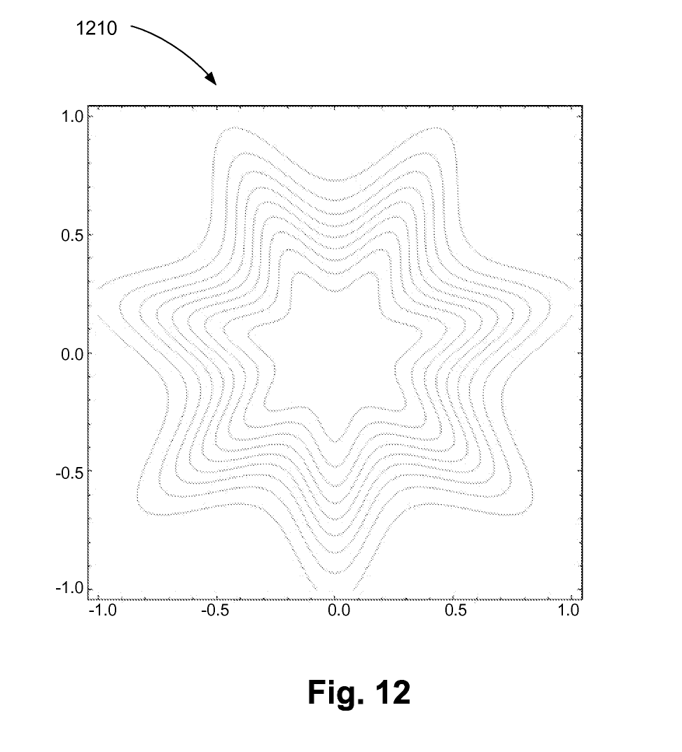

FIG. 12 is a depiction of the representative image 1210 corresponding to the moire pattern 510 of FIG. 5A, and the two differential images 710 and 720 of FIGS. 7A and 7B. The representative image 1210 is actually a grayscale image, but again is shown in FIG. 12 as a contour map owing to the inability photocopying of patent specifications to reliably reproduce grayscale images. The grayscale representative image is in general much more informative visually than the differential images. The advantage is difficult to illustrate with line drawings instead of grayscale image. FIG. 11 shows a second stage of processing which the present inventors have dubbed the “double Riesz noise reducing process” 1100. The first stage is simply the inverse Riesz process 1000 of FIG. 10. The second stage of FIG. 11 operates upon the representative image 1070, 1090 to derive noise reduced versions of the differential gradient phase images 1010 1020 input to the process 1000. The real output representative image 1090 is the input for the process 1100. The real image 1090 is input to a forward Riesz transformation process 1199, which is desirably performed in the Fourier space. The Riesz transformation 1199 applies an inverse Fourier transform step 1130 to the image 1090, the output of which is a spatial image 1135 which in step 1140 is multiplied by the complex Riesz factor 1145, thereby implementing the operations of Equations (24) and (25). The resulting product is an intermediate Fourier image 1145 which is then discrete Fourier transformed in step 1150 to form a complex spatial differential phase image 1155. The complex image 1155 is split in step 1160 into real 1170 and imaginary 1180 gradient phase images. The output images 1170 and 1180 are low noise versions of the original input images 1010 and 1020, having ideally half the noise of the associated original images 1010 and 1020.

FIG. 14 shows a generalised process 1400 for image reconstruction according to the various processes discussed above. Initially in step 1410 an interferogram image including a fringe pattern is captured using a crossed grating interferometer, for example such as the X-ray device 1399. The captured image is stored as a matrix of pixel values in the HDD 1310 in anticipation of digital image processing. At step 1420, the captured image is processes in the frequency domain to identify spectral lobes contained in the captured image, examples of which are depicted in FIG. 6 described above. In step 1430 a pair of orthogonal or substantially orthogonal spectral lobes (side lobes) are selected from the identified lobes and are used as the respective inputs to the process 800 of FIG. 8. As discussed above the process 800 determines the real and imaginary phase gradient images 880 and 870 respectively, which are input to the process 1000 for determination of the representative image 1090. The process 1100 may then be performed to determine noise-reduced real and imaginary phase gradient images.

### EXAMPLE 2

There are various imaging forming processes which can produce a single spatial differential image as output. If such a process is configured to sequentially generate two substantially orthogonal differential images, then the Riesz reconstruction method described herein can be advantageously applied to generate a single representative image. Substantially orthogonal typically means 90° plus or minus a few degrees, generally within 5 degrees. Significantly the arrangements disclosed can accommodate differential images that are within about 30 degrees of orthogonal if compensation is applied. Such arrangements may thus remain regarded as substantially orthogonal. A compensation that recomputes the vertical and horizontal contributions based on the sines and cosines of the deviation from orthogonality angle is readily derived from Equation 6. A one degree departure from perfectly orthogonal induces a directional sensitive error variation of about 1% in the intensity of the combined images. Depending on the application, several degrees of non-orthogonality can be tolerated before the errors become visible or large enough to cause measurable image artefacts.

One particularly interesting application is in Nomarski Differential Interference Contrast (DIC) microscopy. The output of a single imaging operation is essentially a single differential image. By repeating the imaging operation with a rotated Wollaston prism it is possible to obtain a second image with an approximately orthogonal differential. There may be alignment and exposure deviations between the two images. However it is possible to compensate for such deviations using the methods outlined earlier in the description. Once the shift (alignment) and normalisation (exposure) correction have been made, the x-differential image and the y-differential image are encoded as real and imaginary images and input into as the images 1010 and 1020 respectively to the process 1000 shown in FIG. 10. The output representative image 1090 is a single representative image encapsulating the two Nomarski DIC images. Such an image is useful for expert interpretations and further image analysis operations such as cell-counting and biometry. Such an image retains the high frequency emphasis and detail of the individual DIC images, but avoids the anisotropy of the individual input images.

### EXAMPLE 3

There are a number of interferometric imaging systems which generate a single phasor image as the output. The phase usually contains optical path length information spanning many multiples of two pi radians, and so the phasor image displays multiple instances of phase wrapping which often makes the phasor image difficult to interpret. The usual solution is to unwrap the phase. However unwrapping can introduce two difficulties. One difficulty is where phase unwrapping is unambiguous, the unwrapped phase can span such a large dynamic range that details get lost in the range. The other difficulty is where unwrapping is ambiguous (that is the phase contains singularities), and the meaningful unwrapping of phase is not necessarily possible.

Instead of unwrapping the phase, a representative image can be generated by applying the combination of the processes of FIGS. 9 and 10. Consistent with this approach, FIG. 14 also illustrates an alternate implementation where the X-ray device 1399 captures at step 1410 an interferometric single phasor image 1440, represented as a wrapped phase image. The wrapped phase image is used as an input 910 to the process 900, exponentiated in step 920 then the process continues all the way through to outputs 995 and 990 as described earlier for FIG. 9. In FIG. 10, the real and imaginary gradient images 995 and 996 are inputs at 1010 and 1020. After applying the inverse Riesz transform algorithm a representative image 1090 is output. A map of phase discrepancy is output in step 1065 and can be used to gauge the reliability of the representative image 1090 or the representative phasor image 1085.

### EXAMPLE 4

As mentioned earlier, combining differential images using the Riesz transform is efficiently implemented using a complex formulation of the forward and inverse Riesz transforms. In certain situations it may be preferable to use other algebras, such as vector, tensor, or Clifford algebras. For example the expected straightforward extension of the presently described technique to three or more spatial dimensions is no longer simple in purely complex algebra. Extending the processes to vector algebra in two dimensions is an example of an alternative algebraic implementation. In vector algebra the divergence (div) and curl terms have to be evaluated separately. In Clifford algebra, div and curl can again be combined into a single operator that works in dimension 2 and higher.

Equations (15) to (19) show the divergence-like computation of the complex Riesz transform. Equations (21) to (23) show the curl-like computation of complex Riesz transform. Two input images are combined into a vector (field) image. By the fundamental theorem of vector calculus an arbitrary vector field can always be decomposed into the gradient of a scalar field and the curl of a vector field:

g(x, y)=iƒ₁(x, y)+jƒ₂(x, y)=grad{ƒ(x, y)}−curl{h(x, y)} Equation 37

It is then necessary to define Riesz based modifications of the grad and curl operators. As before these operators are easiest to define and implement in the Fourier domain. Once this is done, it is straightforward to implement the Riesz analogues of the div and curl operators acting on g(x, y) to give separately, respectively, the representative scalar image and a (perpendicular vector) discrepancy image. The discrepancy vector is uni-directional, and therefore essentially equivalent to a scalar image.

In two dimensions the advantages of analysis and implementation using the complex notation rather than the vector notation are indubitable.

### INDUSTRIAL APPLICABILITY

The arrangements described are applicable to the computer and data processing industries and particularly for the processing of differential images obtained from crossed gratings. The arrangements are particularly suit to the detection and discrimination of soft tissue through the ability to emphasise subtle high frequency image variations. Thus the arrangements disclosed may offer at least an alternative to magnetic resonance imaging (MRI) for the detection of soft-tissue damage and the like. The described arrangements are particularly useful for X-ray imaging. Nevertheless, as shows by the underlying mathematics, image processing using the Riesz transform and the approaches disclosed can operate across the electromagnetic spectrum notably into the optical frequencies.

The foregoing describes only some embodiments of the present invention, and modifications and/or changes can be made thereto without departing from the scope and spirit of the invention, the embodiments being illustrative and not restrictive.

We claim:

1. A method of forming a representative image from a crossed grating fringe pattern interferogram of an object from an interferometer, the method comprising:
determining a plurality of spectral lobes from the interferogram;
selecting from the plurality of determined lobes, two substantially orthogonal sidelobes, said selected sidelobes representing spatial differential phase information of the interferogram;
applying an inverse Riesz transform to the spatial differential phase information of the selected sidelobes to form a transformed differential phase image; and
forming from the transformed differential phase image, a representative image emphasising high frequency detail information of the object.

2. A method according to claim 1, wherein the representative high frequency detailed image comprises a (real) component and an (imaginary) discrepancy error component, wherein the detailed image can discriminate soft tissue.

3. A method according to claim 1, wherein the interferometer is an x-ray interferometer.

4. A method according to claim 1, in which the Riesz transformation is utilized to combine two differential images in correct orientational distribution proportion to maintain a power spectrum of the images and allow the directional structure in the two images to combine.

5. A method according to claim 4, wherein the power spectrum of the input differential images is maintained without high-pass or low-pass filtering, and the resultant image is representative of an idealized integrated reconstruction having sharper high frequency structures.

6. A method of forming a representative high frequency emphasized phase image from a phasor image, the method comprising:
differentiating the phasor image to produce an intermediate image having two orthogonal components;
constructing a (complex) image from the two orthogonal components of the intermediate image; and
applying an inverse Riesz transform to the constructed image to form a representative high frequency emphasized phase image, wherein the representative high frequency emphasized image comprises a high pass filtered component and a discrepancy component.

7. A method according to claim 6, in which the Riesz transformation is utilized to combine two differential images in correct orientational distribution proportion to maintain a power spectrum of the images and allow the directional structure in the two images to combine.

8. A method according to claim 7, wherein the power spectrum of the input differential images is maintained without high-pass or low-pass filtering, and the resultant image is representative of an idealized integrated reconstruction having sharper high frequency structures.

9. A method of reducing noise in a pair differential images, the method comprising:
combining the differential images into of a complex image having real and imaginary parts;
inverse Riesz transforming the complex image to give an intermediate complex image;
removing the imaginary part of the intermediate complex image;
forward Riesz transforming the real part of the intermediate complex image to form a complex output image having real and imaginary parts;
associating the real and imaginary parts of the output image with the real and imaginary differential image inputs.

10. A method according to claim 9, in which the Riesz transformation is utilized to combine two differential images in correct orientational distribution proportion to maintain a power spectrum of the images and allow the directional structure in the two images to combine.

11. A method according to claim 10, wherein the power spectrum of the input differential images is maintained without high-pass or low-pass filtering, and the resultant image is representative of an idealized integrated reconstruction having sharper high frequency structures.

12. A method of forming a representative image from a pair of differential input images, the method comprising:
determining a plurality of spectral lobes from the differential input images;
selecting from the plurality of determined lobes, two substantially orthogonal sidelobes, said selected sidelobes representing spatial differential phase information of the differential input images;
blending an orientational distribution of spatial differential phase information of the selected sidelobes by maintaining a power spectrum of the differential input images to form a processed differential phase image; and
forming a representative image emphasising high frequency detail information of the object from the processed differential phase image.

13. A method according to claim 12, wherein the differential input images are interferometer images.

14. A method according to claim 12, wherein the processing comprises applying an inverse Riesz transform to the spatial differential phase information.

15. A method according to claim 12, wherein the blended differential phase image is a complex image and the forming comprises extracting the real part of the processed differential phase image as the representative image.

16. A computer readable storage medium having a program recorded thereon, the program being executable by a computer apparatus to form a representative image from a crossed grating fringe pattern interferogram of an object from an interferometer, the program comprising:
code for determining a plurality of spectral lobes from the interferogram;
code for selecting from the plurality of determined lobes, two substantially orthogonal sidelobes, said selected sidelobes representing spatial differential phase information of the interferogram;
code for applying an inverse Riesz transform to the spatial differential phase information of the selected sidelobes to form a transformed differential phase image; and
code for forming from the transformed differential phase image, a representative image emphasising high frequency detail information of the object.

17. A computer readable storage medium having a program recorded thereon, the program being executable by a computer apparatus to form a representative high frequency emphasized phase image from a phasor image, the method comprising:
code for differentiating the phasor image to produce an intermediate image having two orthogonal components;
code for constructing a (complex) image from the two orthogonal components of the intermediate image; and
code for applying an inverse Riesz transform to the constructed image to form a representative high frequency emphasized phase image, wherein the representative high frequency emphasized image comprises a high pass filtered component and a discrepancy component.

18. A computer readable storage medium having a program recorded thereon, the program being executable by a computer apparatus to form a representative image from a pair of differential input images, the method comprising:
code for determining a plurality of spectral lobes from the differential input images;
code for selecting from the plurality of determined lobes, two substantially orthogonal sidelobes, said selected sidelobes representing spatial differential phase information of the differential input images;
code for blending an orientational distribution of spatial differential phase information of the selected sidelobes by maintaining a power spectrum of the differential input images to form a processed differential phase image; and
code for forming a representative image emphasising high frequency detail information of the object from the processed differential phase image.

19. A computer apparatus for forming a representative high frequency emphasized phase image from a phasor image, the apparatus comprising:
means for differentiating the phasor image to produce an intermediate image having two orthogonal components;
means for constructing a (complex) image from the two orthogonal components of the intermediate image; and
means for applying an inverse Riesz transform to the constructed image to form a representative high frequency emphasized phase image, wherein the representative high frequency emphasized image comprises a high pass filtered component and a discrepancy component.

20. An x-ray interferometer system comprising:
an x-ray device capturing a crossed grating fringe pattern interferogram of an object, and a computer apparatus forming a representative image from the captured crossed grating fringe pattern interferogram, the representative image being formed by:
determining a plurality of spectral lobes from the interferogram;
selecting from the plurality of determined lobes, two substantially orthogonal sidelobes, said selected sidelobes representing spatial differential phase information of the interferogram;
applying an inverse Riesz transform to the spatial differential phase information of the selected sidelobes to form a transformed differential phase image; and
forming from the transformed differential phase image, a representative image emphasising high frequency detail information of the object.
